(19) United States
(12) Patent Application Publication
(10) Pub. No.: US 2014/0143143 A1
(43) Pub. Date: May 22, 2014

(54) USING CARD IMAGE TO EXTRACT BANK ACCOUNT INFORMATION

(71) Applicants: Jonathan David Fasoli, Aliso Viejo, CA (US); Pranay Kapadia, Santa Clara, CA (US); William Michael Dorsch, De Pere, WI (US)

(72) Inventors: Jonathan David Fasoli, Aliso Viejo, CA (US); Pranay Kapadia, Santa Clara, CA (US); William Michael Dorsch, De Pere, WI (US)

(21) Appl. No.: 13/679,962

(22) Filed: Nov. 16, 2012

(51) Int. Cl. G06Q 20/34; G06Q 20/42

(52) U.S. Cl. CPC G06Q 20/347; G06Q 20/42
USPC 705/44; 705/39

(57) ABSTRACT

A method to complete a sales transaction. The method includes (a) obtaining, by a merchant mobile device, a digital image of a financial card of a consumer, wherein the digital image captures a code and an account number, (b) requesting a payment of the sales transaction by (i) extracting, by a processor of the merchant mobile device using optical character recognition, the account number and the code, (ii) identifying a depository financial institution and a consumer financial account based on the code and the account number, respectively, and (iii) sending a request to the depository financial institution to transfer an amount of the payment from the consumer financial account to a merchant financial account controlled by the merchant, and (c) receiving, by the merchant mobile device, a confirmation of completing the electronic funds transfer, wherein the sales transaction is completed in response to the confirmation.

### SUMMARY

In general, in one aspect, the invention relates to a method to complete a sales transaction. The method includes (a) obtaining, by a merchant mobile device of a merchant, a digital image of a financial card of a consumer, wherein the digital image captures a code and an account number displayed in a text format on the financial card, (b) requesting, in response to obtaining the digital image, a payment of the sales transaction by extracting, by a processor of the merchant mobile device using optical character recognition of the digital image, the account number and the code, identifying a depository financial institution and a consumer financial account based on the code and the account number, respectively, wherein the consumer financial account is held at the depository financial institution and controlled by the consumer, and sending a request to the depository financial institution to transfer, via an electronic funds transfer, an amount of the payment from the consumer financial account to a merchant financial account controlled by the merchant, and (c) receiving, by the merchant mobile device, a confirmation of completing the electronic funds transfer, wherein the sales transaction is completed in response to the confirmation.

In general, in one aspect, the invention relates to a system for completing a sales transaction. The system includes (a) a merchant mobile device of a merchant, configured to obtain a digital image of a financial card of a consumer, wherein the digital image captures a code and an account number displayed in text format on the financial card, extract, using optical character recognition of the digital image, the account number and the code, and receive a confirmation of transferring, via an electronic funds transfer from a consumer financial account controlled by the consumer to a merchant financial account controlled by the merchant, an amount of a payment for the sales transaction, wherein the sales transaction is completed in response to the confirmation, (b) a processor of a computer server, and (c) a payment engine executing on the processor and configured to identify a depository financial institution and the consumer financial account based on the code and the account number, respectively, wherein the consumer financial account is held at the depository financial institution, and send a request to the depository financial institution to compete the electronic funds transfer, and (d) a repository coupled to the processor and configured to store the code, the account number, and a record of the electronic funds transfer.

In general, in one aspect, the invention relates to a non-transitory computer readable medium storing instructions to complete a sales transaction. The instructions comprising functionality to (a) obtain, by a merchant mobile device of a merchant, a digital image of a financial card of a consumer, wherein the digital image captures a code and an account number displayed in a text format on the financial card, (b) request, in response to obtaining the digital image, a payment of the sales transaction by extracting, using optical character recognition of the digital image, the account number and the code, identifying a depository financial institution and a consumer financial account based on the code and the account number, respectively, wherein the consumer financial account is held at the depository financial institution and controlled by the consumer, and sending a request to the depository financial institution to transfer, via an electronic funds transfer, an amount of the payment from the consumer financial account to a merchant financial account controlled by the merchant, and (c) receive, by the merchant mobile device, a confirmation of completing the electronic funds transfer, wherein the sales transaction is completed in response to the confirmation.

Other aspects of the invention will be apparent from the following detailed description and the appended claims.

### BRIEF DESCRIPTION OF DRAWINGS

FIG. 1 shows a schematic diagram of a system of using card image to extract bank account information in accordance with one or more embodiments of the invention.

FIG. 2 shows a flowchart of a method of using card image to extract bank account information in accordance with one or more embodiments of the invention.

FIGS. 3A-3D show an example of using card image to extract bank account information in accordance with one or more embodiments of the invention.

FIG. 4 shows a diagram of a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

A credit card or a debit card generally requires electronic authorization for a transaction. The transaction may be additionally secured with the personal identification number (PIN) authentication system. Merchants accepting the credit card or debit card for payment are often required to have an electronic authorization device at the point of sale (POS), and sometimes also a separate PIN pad to enter the PIN. These devices are often expensive.

Remote deposit refers to the ability to deposit a check into a bank account from a remote location, without having to physically deliver the check to the bank. This functionality is typically accomplished by scanning a digital image of a check into a computer, then transmitting that image to the bank. The practice of remote deposit became legal in the United States in 2004 when the Check Clearing for the 21st Century Act (or Check 21 Act) took effect.

Automated Clearing House (ACH) is an electronic network for financial transactions in the United States. Rules and regulations that govern the ACH network are established by NACHA (formerly the National Automated Clearing House Association) and the Federal Reserve. An ACH transaction starts with a receiver authorizing an originator to issue an ACH debit or credit to an account. A receiver is the account holder that grants the authorization. An originator can be a person or a company (such as the gas company, a local cable company, or a person's employer). Accounts are identified by the bank's routing number and the account number within that bank.

In accordance with the rules and regulations of ACH, no financial institution may issue an ACH debit transaction (and sometimes also a credit) towards an account without prior authorization from the receiver. Depending on the ACH transaction, the originator must receive written (SEC codes: ARC, POP, PPD), oral (TEL), or electronic (WEB) authorization from the receiver. Written authorization constitutes a signed form giving consent on the amount, date, and frequency (if applicable) of the transaction. If oral authorization is not audio-recorded, the originator must send a receipt of the transaction details before or on the transaction date. An electronic authorization must include a customer being presented the terms of the agreement and typing or selecting some form of an “I agree” statement and proof of this authorization must be maintained by the originating financial institution for four to seven years. Once authorization is acquired, the originator then creates an ACH entry to be given to an Originating Depository Financial Institution (ODFI), which can be any financial institution that does ACH origination. This ACH entry is then sent to an ACH operator that passes it on to the Receiving Depository Financial Institution (RDFI), where the receiver's account is issued either a debit or credit. The BACS transfer in the United Kingdom (U.K.) is the equivalent of the ACH network in the United States, and serve as the inter-bank electronic transaction clearing system in the U.K.

For the thousands of banking transactions that occur each day, the bank aggregates the transactions on its own system and makes batch payments to the other parties in the transactions. In one or more embodiments of the invention, core banking is a general term used to describe the services provided by a group of networked bank branches where “core” stands for “centralized online real-time environment.” Based on the core banking system, bank customers may access their funds and other simple transactions from any of the member branch offices. Generally, all the bank's branches access applications from centralized data centers, such that the deposits made are reflected immediately on the bank's servers and the customer can withdraw the deposited money from any of the bank's branches throughout the world. In the past without the core banking system, it took at least a day for a transaction to reflect in the account because each branch had local servers, and the data from the local server in each branch was sent in a batch to the servers in the datacenter only at the end of the day.

Embodiments of the invention substitute a card-based transaction (e.g., based on a debit or credit card) by a bank-based transaction. Card-based transactions are processed over a card network (e.g., a credit and/or debit card network) and are subject to interchange fees. Bank-based transactions settle through core banking systems, ACH, and the Federal Reserve System electronically, where the fee structure for these types of payments is much lower.

In one or more embodiments, banks provide access to their core-banking system to a third party service provider (e.g., a bill pay or other core banking service providers). This technique allows a third party service provider to give the originating financial institution instruction to immediately debit funds from a user's account and move the funds into a financial institution's general ledger account, which is a demand deposit account held in the financial institution's name or a demand deposit account at the financial institution held on behalf of a third party. The authorization for this debit to the consumer's account is essentially identical to that required in the ACH network and originating financial institutions must maintain evidence of the obtained authorization. Such funds are referred to as “Good Funds,” because the debit will fail if the money isn't in the account; Non-sufficient Funds (“NSF”) risk is essentially eliminated. Good Funds transactions allow third party providers (and the financial institutions they serve) to query the balance in a demand deposit account before scheduling the debit. This capability allows the financial institution to ensure that the funds are available before processing the credit to the receiver in the transaction. Additionally, the funds are debited and moved instantaneously into the general ledger, financial institution-owned or on-behalf of account before the credit side of the transaction to the receiver is initiated. In one or more embodiments, the third party service provider accesses the bank's core banking system, debit funds from the user's account in real-time to assure that the funds are in the account as Good Funds, and move it to the bank's general ledger. Accordingly, the funds are then transferred (typically in batches) to the third party service provider.

In one or more embodiments, either a real-time Good Funds transfer or an ACH is used to process a financial card payment of a consumer at the point of sale of a merchant. In this manner, the transaction flows through the bank channel (e.g., the core banking system) on the bank's proprietary network instead of a credit card processing network.

In one or more embodiments, the built-in camera functionality of a general purpose computing device (e.g., a smartphone, a tablet computer, a notebook computer, or other computing device with communication capability) is used to process a financial card (e.g., credit card, debit card, or other card embossed with banking information) transaction for a merchant. Accordingly, the merchant processes the transactions without needing any dedicated card swiping or card information input hardware. In one or more embodiments, both the consumer's credit/debit card number and the consumer's bank account information are embossed on the front of the financial card. Accordingly, a native application on a smartphone of the merchant extracts bank account information from the image of the front of the financial card. In particular, the native application processes the transaction by accessing a depository financial institution based on the bank account information. In contrast, the dedicated card swiping hardware would process the transaction via a credit card transaction network based on the credit/debit card number.

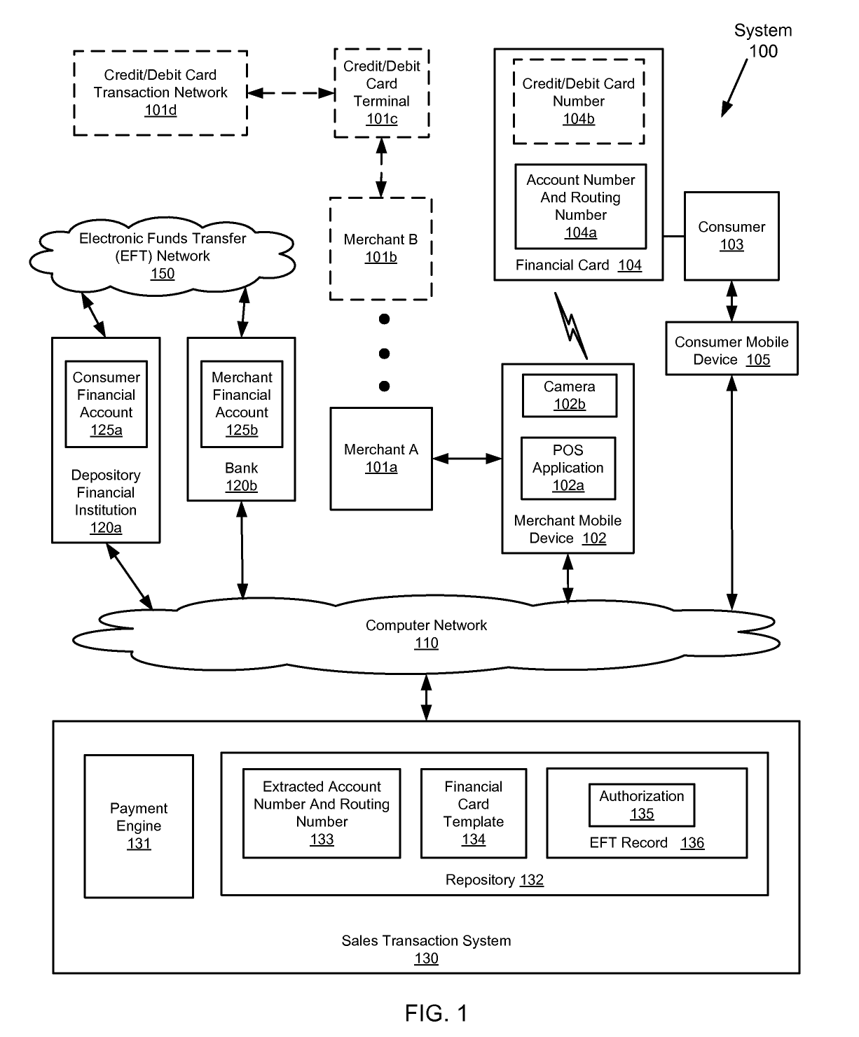

FIG. 1 depicts a schematic block diagram of a system (100) in accordance with one or more embodiments of the invention. In one or more embodiments of the invention, one or more of the modules and elements shown in FIG. 1 may be omitted, repeated, and/or substituted. Accordingly, embodiments of the invention should not be considered limited to the specific arrangements of modules shown in FIG. 1.

As shown in FIG. 1, the system (100) includes a merchant A (101a) having a merchant mobile device (102) that is installed with a point of sale (POS) application (102a) and a camera (102b), a merchant B (101b) having a credit/debit card terminal (101c) coupled to a credit/debit card transaction network (101d), a consumer (103) having a consumer mobile device (105) and a financial card (104) embossed with a set consisting of an account number and a routing number (104a) and a credit/debit card number (104b), and a sales transaction system (130) having a payment engine (131) and a repository (132) storing a set of extracted account number and routing number (133), a financial card template (134), an authorization record (135), and an electronic funds transfer (EFT) record (136). In addition, a merchant financial account (125b) is held at a bank (120b) for the merchant A (101a). A consumer financial account (125a) is held at a depository financial institution (120a) for the consumer (103). In particular, bank account information of the consumer financial account (125a) is embossed on the financial card (104) of the consumer (103) as the account number and routing number (104a).

Further as shown in FIG. 1, the depository financial institution (120a), the bank (120b), the merchant mobile device (102), the consumer mobile device (105), and the sales transaction system (130) are coupled via a computer network (110). For example, the computer network (110) may include a wireless communication network (e.g., a mobile phone network) and wired and/or wireless portions of public and/or private data network, such as wide area networks (WANs), local area networks (LANs), Internet, etc. Further, the depository financial institution (120a) and the bank (120b) are coupled via an EFT network (150). For example, the EFT network (150) may be a proprietary network configured to facilitate direct communication between the depository financial institution (120a) and the bank (102b) for processing EFT activities. In one or more embodiments, such proprietary network is a secured network to limit accessibility to information related to the EFT activities. In one or more embodiments, the proprietary network may include a mobile telephone network, a television-cable network, and/or a public switched telephone network (PSTN).

In one or more embodiments, the consumer (103) is a credit/debit card holder who may be an individual using a personal credit/debit card or a business entity using a business credit/debit card. The merchant B (101b) is an individual or a business entity providing goods or services that accepts credit/debit card payments for products or services sold to a credit/debit card holder, such as the consumer (103). Generally, the merchant B (101b) uses the credit/debit card terminal (101c) to submit the credit/debit card payments for processing by the credit/debit card transaction network (101d). For example, the credit/debit card terminal (101c) may be a stand alone device with a magnetic card swiper or a pin pad for swiping or entering credit card information (e.g., credit/debit card number (104b)).

In one or more embodiments, the merchant A (101a) is an individual or a business entity that accepts payments for products or services sold to a credit/debit card holder, such as the consumer (103) having the financial card (104). Specifically, the financial card (104) is embossed with the account number and routing number (104a) in addition to the conventional credit/debit card number (104b). In contrast to the merchant B (101b) accepting payment from the consumer (103) using the financial card (104) based on the credit/debit card number (104b), the merchant A (101a) accepts payment from the consumer (103) using the financial card (104) based on the account number and routing number (104a).

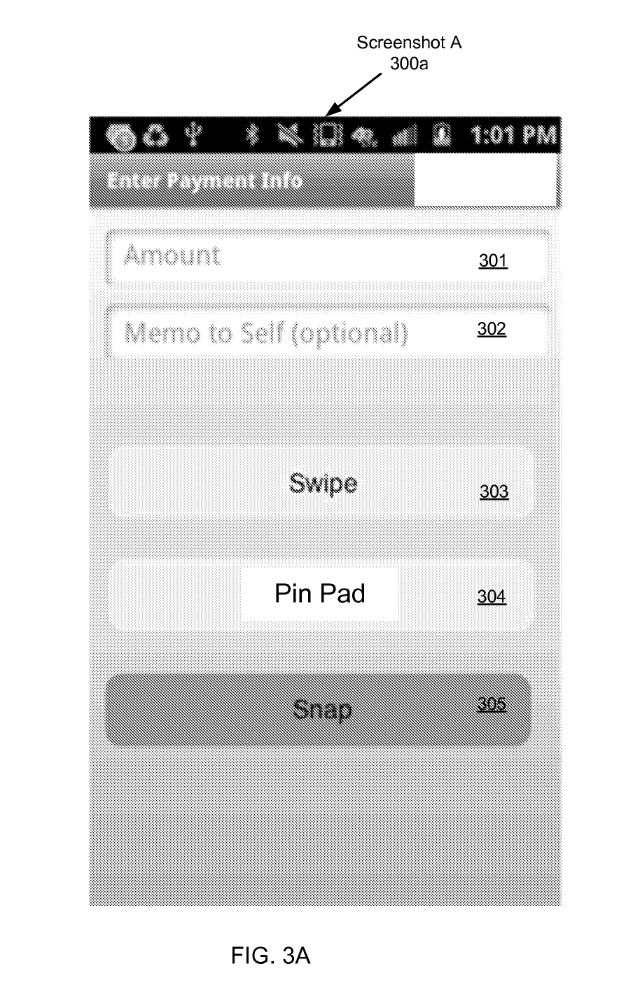

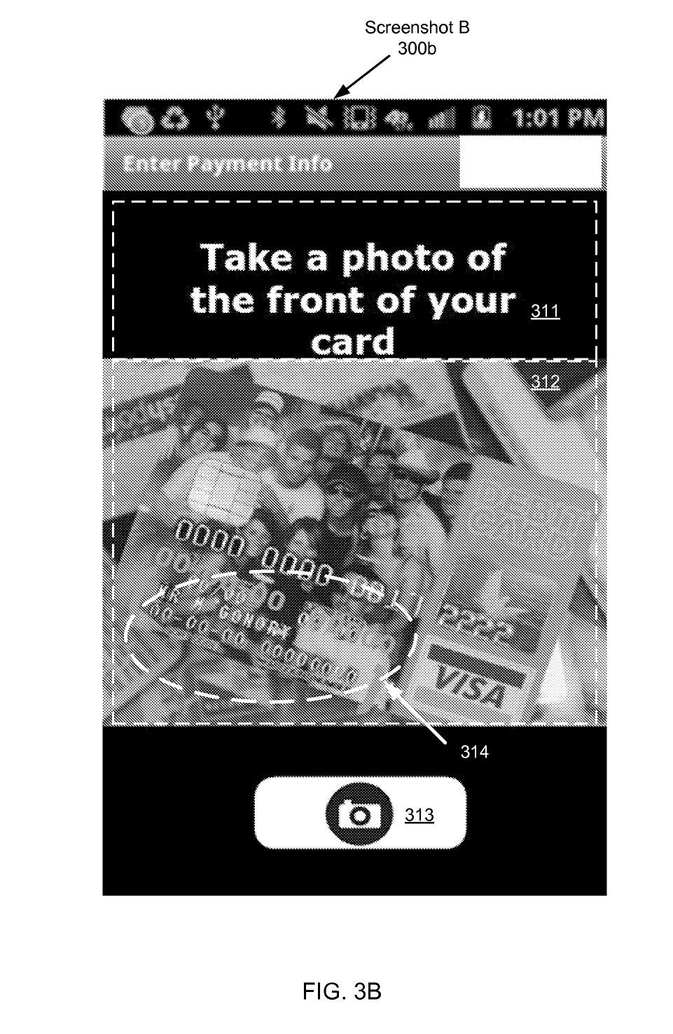

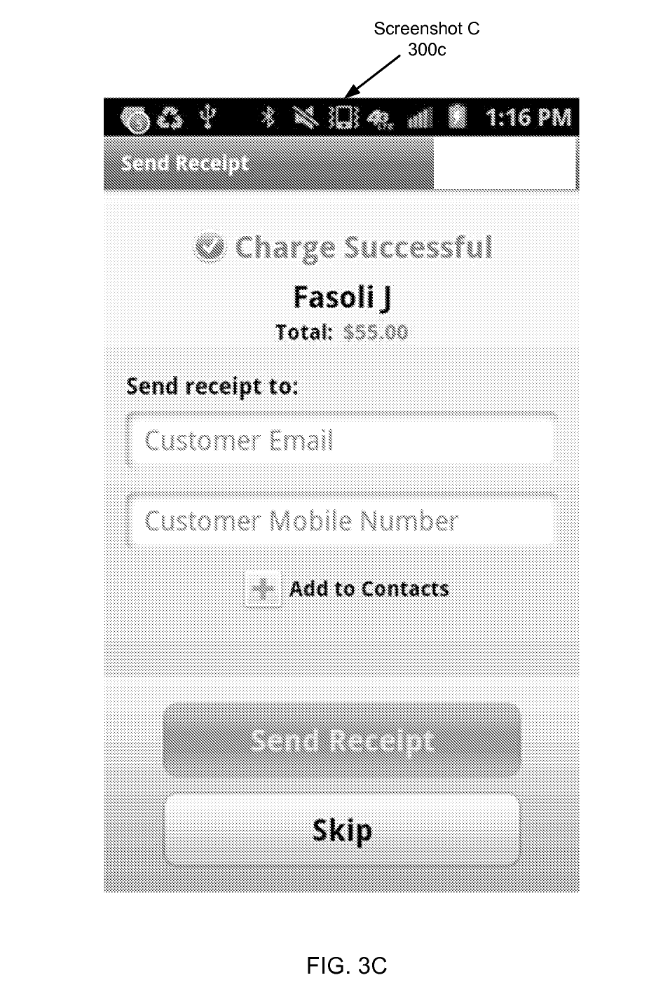

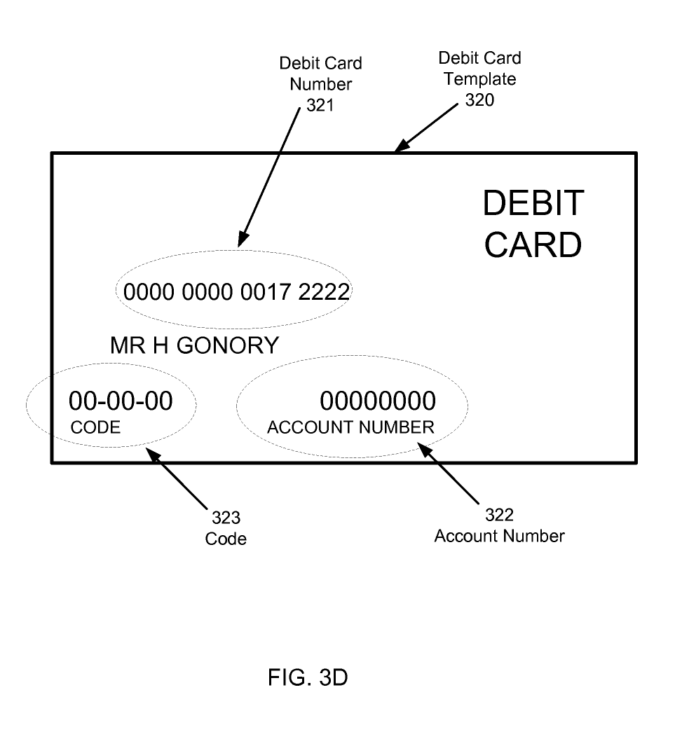

In one or more embodiments, the merchant mobile device (102) includes the POS application (102a) that is configured to process a payment for a sales transaction from the consumer (103) using the financial card (104). Specifically, the POS application (102a) first obtains a digital image of the front of the financial card (104). In particular, the digital image captures the account number and routing number (104a) displayed in text format, which are embossed on the financial card (104). In one or more embodiments, the merchant mobile device (102) includes the camera (102b) that is configured to generate the digital image. In response to obtaining the digital image, the POS application (102a) extracts, using optical character recognition of the digital image, numerical values of the account number and routing number (104a), which are then stored in the repository (132) as the extracted account number and routing number (133). In one or more embodiments, the POS application (102a) analyzes the digital image based on the financial card template (134) to locate a portion of the digital image that corresponds to the embossed account number and routing number (104a). Accordingly, the optical character recognition is applied to the portion of the digital image corresponding to the embossed account number and routing number (104a). An example of the financial card template (134) is shown in FIG. 3D.

In one or more embodiments, the POS application (102a) initiates the EFT based payment by sending a request with the extracted account number and routing number (133) as the EFT source account to the sales transaction system (130), which is configured to orchestrate the EFT based payment. In addition, the request also includes information identifying the merchant financial account (125b) and the bank (120b) as the EFT destination account based on a merchant profile stored in the POS application (102a). In one or more embodiments, the EFT is performed using the EFT network (150) based on pre-determined protocols supported by the depository financial institution (120a) and the bank (120b). Upon completing the EFT, the POS application (102a) receives a confirmation of transferring an amount of a payment for the sales transaction. In one or more embodiments, the EFT transfers the amount from the consumer financial account (125a) controlled by the consumer (103) to the merchant financial account (125b) controlled by the merchant A (101a). In response to the confirmation of transferring the amount of the payment, the merchant A (101a) completes the sales transaction by delivering a product or performing a service.

In one or more embodiments, the sales transaction system (130) includes the payment engine (131) that is configured to carry out the EFT based payment initiated by the POS application (102a). In response to the request from the POS application (102a) to process the payment, the payment engine (131) identifies, as the source account of the EFT, the depository financial institution (120a) and the consumer financial account (125a) based on the request. Further, the payment engine (131) identifies, as the destination account of the EFT, the merchant financial account (125b) and the bank (120b) based on the request. Accordingly, the payment engine (131) sends a request to the depository financial institution (120a) to complete the EFT to the merchant financial account (125b).

Generally, the EFT payment requires consumer authorization. In one or more embodiments, the authorization is received from the consumer (103) by the depository financial institution (120a) via the merchant mobile device (102) as a part of the request to complete the EFT. For example, the merchant (101a) may hand over the merchant mobile device (102) to the consumer (103) who enters a pin code into the POS application (102a) as the authorization.

In one or more embodiments, the depository financial institution (120a) sends, in response to the request to complete the EFT, an EFT notification to the consumer mobile device (105). For example, the phone number of the consumer mobile device (105) may be stored in an account profile at the depository financial institution (120a) for the consumer financial account (125a). In response to the EFT notification, the depository financial institution (120a) receives from the consumer mobile device (105) an authorization (e.g., a pin code) sent by the consumer (103).

In response to receiving the authorization from the consumer (103), the amount of the payment is transferred from the consumer financial account (125a) to the merchant financial account (125b). In response to completing the EFT, the sales transaction system (130) receives confirmation from the depository financial institution (120a) and/or the bank (120b). Accordingly, the confirmation is stored in the repository (132) as the EFT record (136), which may include a record (e.g., authorization record (135)) of the aforementioned consumer authorization. In one or more embodiments, the payment engine (131) is further configured to initiate a fee payment associated with the EFT to an operator of the sales transaction system (130). For example, the fee payment may be deducted from the amount of the payment that is transferred to the merchant financial account (125b).

In one or more embodiments, the EFT is based on an Automated Clearing House (ACH) transaction. Specifically, the ACH transaction debits the consumer financial account (125a) according to rules and regulations of ACH. In such embodiments, the depository financial institution (120a) may be a financial institution, or associated with a financial institution, that participates in the Automated Clearing House (ACH) or the European Automated Clearing House (EACH), at the request of and by agreement with its customers, such as the consumer (103). Within the ACH or the EACH, the depository financial institution (120a) may be an Originating Depository Financial Institution (ODFI) or a Receiving Depository Financial Institution (RDFI), or a payment processing service associated with either.

In those embodiments using the ACH transaction, the request to complete the EFT includes an ACH transfer entry package instructing the depository financial institution (120a) to initiate the EFT using the ACH transaction based on the authorization from the consumer (103). Specifically, the authorization explicitly authorizes the ACH transaction. For example, the ACH transfer entry package may include the consumer's name, ID number and/or security code(s), date, amount of transferred funds authorized, mailing address, name and account information for the financial institution to which transfer entry may be presented, an accredited bill payment access code number, and any other information necessary to facilitate payment based on the sales transaction. In one or more embodiments, the ACH transfer entry package is generated by the POS application (102a) and sent to the sales transaction system (130) as a part of the request to process the payment. In turn, the sales transaction system (130) may send the ACH transfer entry package to the depository financial institution (120a) as the ODFI or the bank (120b) as the RDFI. In one or more embodiments, the ACH transfer entry package is generated by the sales transaction system (130) based on information provided from the POS application (102a). Once the ACH transaction is completed, a record of the ACH transaction is then stored in the repository (132) as the EFT record (136).

In one or more embodiments of the invention, all or a portion of the payment engine (131) resides on the merchant mobile device (102), or a server associated with the merchant mobile device (102), or an associated communication service provider (not shown). For example, the POS application (102a) installed on the merchant mobile device (102) may include the functionality to generate and submit the ACH transfer entry package for setting up the ACH. Subsequently, the EFT may then be accomplished by completing the pre-authorized ACH transaction.

In one or more embodiments of the invention, the sales transaction system (130) may be operated by a service provider, by the depository financial institution (120a), or by the bank (120b). For example, all or a portion of the payment engine (131) may reside on a third party server (not shown). The third party server (not shown) may be associated with a bill-pay service, a financial institution, a credit card company, an internet financial service, or other similar payment service provider. In one or more embodiments, the POS application (102a) is provided by the operator of the sales transaction system (130). For example, the POS application (102a) may be downloaded from the third party server.

In one or more embodiments, a credit card processor entity or a credit card company of the credit/debit card transaction network (101d) may operate the sales transaction system (130) and provide the POS application (102a) to the merchant A (101a) while the merchant A (101a) is waiting for a credit card processing merchant account to be set up under the credit card processor entity. Accordingly, before the merchant A (101a) is ready to process credit/debit card payment in the conventional way via the credit/debit card transaction network (101d), the merchant A (101a) can immediately start accepting payment from the consumer (103) using the financial card (104) based on the account number and routing number (104a) instead of based on the credit/debit card number (104b). In another example, a bill-pay service, a financial institution, an internet financial service, or other similar payment service provider may operate the sales transaction system (130) and provide the POS application (102a) to the merchant A (101a). In such example, the bill-pay service, financial institution, internet financial service, or other similar payment service provider may compete with the credit/debit card transaction network (101d) in providing payment service to the merchants, such as the merchant A (101a) and the merchant B (101b).

Although the system (100) is described with the set of account number and routing number (104a), those skilled in the art with the benefit of this disclosure will recognize that the routing number may be other types of code associated with the consumer financial account (125a) that is specified by the depository financial institution (120a).

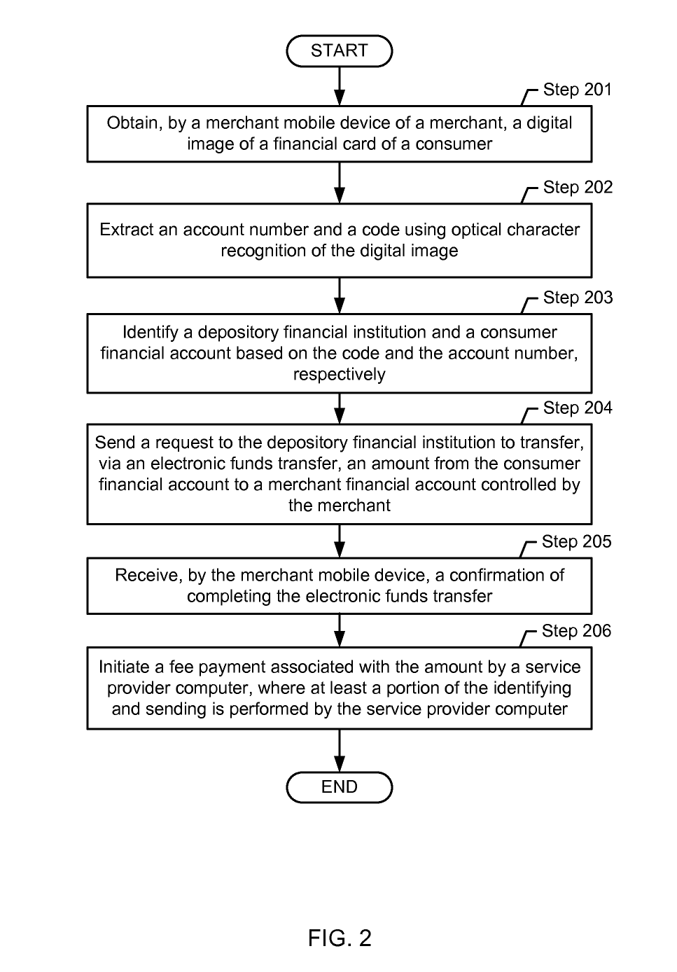

FIG. 2 depicts a flowchart of a method in accordance with one or more embodiments of the invention. In one or more embodiments of the invention, one or more of the steps shown in FIG. 2 may be omitted, repeated, and/or performed in a different order. Accordingly, embodiments of the invention should not be considered limited to the specific arrangements of steps shown in FIG. 2. In one or more embodiments, the method described in reference to FIG. 2 may be practiced using the system (100) described in reference to FIG. 1 above.

Initially in Step 201, a digital image of a financial card of a consumer is obtained by a merchant mobile device (e.g., a smartphone, a tablet computer, a notebook computer, or other computing device with communication capability) of a merchant. In particular, the digital image is obtained to process payment for a sales transaction where the consumer purchases a merchandise or service from the merchant. In one or more embodiments, the financial card is a credit card or a debit card that is embossed with the credit/debit card number as well as bank account information of the consumer. Accordingly, the digital image captures the bank account information as a code and an account number. Specifically, the code and the account number are displayed (i.e., embossed) in a text format on the financial card. For example, the code may be a routing number identifying a particular banking entity where the bank account is held. In one or more embodiments, the digital image is generated using camera functionality of the merchant mobile device. In one or more embodiments, the digital image is generated by other means (e.g., using camera functionality of a consumer's mobile device) and sent (e.g., via email or other messaging services) to the merchant mobile device. In response to obtaining the digital image and based on the captured bank account information, a payment of the sales transaction is requested by the Steps 202 through 204.

In one or more embodiments, at least a portion of the Steps 202 through 204 are performed by a processor of the merchant mobile device and/or a computer server coupled to the merchant mobile device. For example, the computer server may be operated by a third party service provider, such as a bill-pay service, a financial institution, a credit card company, an internet financial service, a communication service provider associated with the merchant mobile device, or other similar payment service provider. In one or more embodiments, the payment processing functionality of the merchant mobile device is provided by such third party service provider. For example, a payment application may be downloaded from the computer server operated by the third party service provider and installed on the merchant mobile device. In one or more embodiments, the third party service provider collects a fee for providing the payment processing service.

In Step 202, the account number and the code are extracted from the digital image by the processor of the merchant mobile device using optical character recognition. In one or more embodiments, the digital image is analyzed based on a financial card template to locate a portion of the digital image that corresponds to the embossed bank account information. Accordingly, the optical character recognition is applied to the corresponding portion of the digital image to extract the embossed account number and code. An example of the financial card template is shown in FIG. 3D.

In Step 203, a depository financial institution and a consumer financial account are identified based on the code and the account number, respectively. For example, the information mapping the code to a depository financial institution may be stored in a database accessible by the merchant mobile device.

In Step 204, a request is sent to the depository financial institution to transfer, via an electronic funds transfer (EFT), an amount of the payment from the consumer financial account to a merchant financial account controlled by the merchant. In one or more embodiments, the banking institution information and the merchant financial account information are stored in a merchant profile in the merchant mobile device.

In Step 205, a confirmation of completing the electronic funds transfer (EFT) is received by the merchant mobile device. Accordingly, the merchant completes the sales transaction in response to the confirmation. For example, the merchant may deliver the merchandise to the consumer or perform a service ordered by the consumer. Generally, the EFT requires consumer authorization. In one or more embodiments, the EFT is based on an ACH transaction. Additional details of consumer authorization for the EFT and performing the EFT based on the ACH transaction are described in reference to FIG. 1 above. In one or more embodiments, the EFT is based on an ACH transaction. In one or more embodiments, the EFT is based on a core banking system transfer, such as a Good Funds debit and credit.

In Step 206, a fee payment associated with the amount transferred via the EFT is initiated, e.g., by the third party service provider computer performing at least a portion of the Steps 202 through 204. Additional details of the fee payment are described in the example shown in FIGS. 3A-3D below.

FIGS. 3A-3D show an application example in accordance with one or more embodiments of the invention. This example application may be practiced using the system (100) of FIG. 1 and based on the method described with respect to FIG. 2 above.

The example depicted in FIGS. 3A-3D is related to a scenario of a cab driver John Roy waiting for a passenger Mary to pay the cab fare. Mary suddenly realizes that she does not have any cash in her purse and asks John if he accepts card payment (in this case a debit card). Mary's debit card has both her card number and bank account information embossed on the front side of the card (embedded in the account number and a sort code). Although John is not yet set up to accept card payments, he remembers that a fellow cab driver Henry once told him how easy it was to get going with the payment service provider “ABC.GoPayment.” John uses his smartphone to search for “ABC.GoPayment” and quickly downloads and installs the “ABC.GoPayment.Xpress” mobile application onto his smartphone. While installing the mobile application “ABC.GoPayment.Xpress,” John specifies his bank account in a merchant profile and directs any collected customer payments to be sent there. FIGS. 3A, 3B, and 3D show example screenshots of the mobile application “ABC.GoPayment.Xpress” on John's smartphone when Mary pays her cab fare using her debit card. FIG. 3D shows a debit card template (320) used by “ABC.GoPayment.Xpress” to process Mary's card.

FIG. 3A shows a screenshot A (300a) displayed on John's smartphone that allows John to select one of three payment processing options. The swipe button (303) would activate a magnetic card swiping module if it is attached to John's smartphone. In this configuration, John can swipe Mary's credit card and process the payment as a conventional “card present” credit card payment. The Pin Pad button (304) could also activate a Pin Pad software module of “ABC.GoPayment.Xpress”, such that John can enter Mary's credit card number using his smartphone keyboard or a dedicated Pin Pad device to process the payment as a conventional “card not present” credit card payment. Since John does not have a merchant account and is not yet set up for accepting credit card payments, clicking on either of the swipe button (303) or the Pin Pad button (304) would re-direct John's smartphone display to show an interface menu guiding him to set up a merchant account for processing credit card payments. John decides to try this later after he collects Mary's payment.

Returning to the discussion of the three payment processing options depicted in the screenshot A (300a). The snap button (305) activates the camera and an EFT based POS payment software module of “ABC.GoPayment.Xpress,” which allows John to take a picture of Mary's debit card to translate the card image into bank account information. The EFT based POS payment software module then processes the payment using the method described in reference to FIG. 2 above, using the same processing rails as a bank-scheduled transaction (over the BACS rails in the U.K. or ACH in the U.S.). Core banking Good Funds transfers (e.g., debits and credits) may also be used for merchants and consumers in the same banking network. In addition, the data entry fields (301) and (302) allow John to enter the payment amount for the cab fare and any reminder as a memo describing appropriate information of this transaction.

When John clicks the snap button (305), a camera interface is displayed on John's smartphone as shown in the screenshot B (300b) of FIG. 3B. The screenshot B (300b) shows an instruction (311) asking John to take a photo of the front of Mary's card. An image is displayed in the camera view field (312) reflecting what the camera is pointed at. In addition, the camera button (313) allows John to snap a photo of Mary's debit card, which is shown in the camera view field (312). The EFT based POS payment software module has the ability to recognize Mary's card image even though it is not perfectly aligned with edges of the camera view field (312). As noted above, the EFT based POS payment software module locates Mary's card information in the card image and translates it into the required bank account information based on a financial card template shown in FIG. 3D. Accordingly, the recognized region within Mary's card image is highlighted by the superimposed bank account number and code (314). In the example image shown in FIG. 3B, the code is a bank routing number (or a sort code in U.K.) extracted using OCR as 00-00-00, the bank account number is extracted using OCR as 00000. The transaction is processed almost instantaneously and can be settled via the ACH/BAGS network or through a Good Funds debit directly to an issuing bank's core banking system.

FIG. 3C shows a screenshot C (300c) on John's smartphone confirming that the charge is successful using Mary's debit card. For processing fee purposes, the transaction would be treated similarly to a bill pay transaction or scheduled ACH transaction; this significantly reduces the processing fee for the merchant. The screenshot C (300c) also shows data entry fields for John to enter Mary's email address and/or her mobile phone number for sending the cab fare receipt to Mary. The confirmation indicates that Mary's bank account is deducted by an amount $55.00. A small fraction of this amount is deducted as service fee to “ABC.GoPayment” with the remainder transferred to John's bank account that was previously specified in the merchant profile of “ABC.GoPayment.Xpress.” Comparing to the service fee that John may have to pay a conventional credit card processor, John decides to use “ABC.GoPayment” for all his future customers who uses debit cards.

After collecting Mary's payment, John decides to apply for a merchant account so that he may accept credit cards that do not have embossed bank account information of the card holders. He returns to the starting menu page of the “ABC.GoPayment.Xpress” shown in FIG. 3A and clicks on either of the swipe button (303) or the Pin Pad button (304). John then gets re-directed to an interface menu for setting up a merchant account under “XYZ credit card processor.” Three days later, John receives a stand alone credit card terminal with a magnetic card swiper and a keypad so that he can have a choice to either swipe customer credit cards or manually enter the credit card numbers when accepting credit card payments from customers. When John completes his merchant account set up, “XYZ credit card processor” pays a one time referral fee to “ABC.GoPayment.” Based on a pre-arranged business agreement, every time John uses “ABC.GoPayment.Xpress” to process a credit card payment, “XYZ credit card processor” may pay a service fee to “ABC.GoPayment.”

FIG. 3D shows a debit card template (320) for Mary's debit card. As shown, the debit card template (320) identifies approximate locations where the embossed debit card number (321), code (323), and account number (322) are located.

Although the example depicted in FIGS. 3A-3D above refers to a mobile application provided by the bill-pay service provider “ABC.GoPayment,” the variation of the mobile application may also be available from “XYZ credit card processor.” If the scenario if John downloaded and installed this variation from “XYZ credit card processor” with the purpose of setting up a merchant account to process credit card payment, the snap button (305) allows John to process payment using Mary's debit card in the interim while waiting for the merchant account set up to be completed. In this example, when John collects Mary's payment, “ABC.GoPayment” will pay “XYZ credit card processor” a portion of the service fee deducted from the $55.00 cab fare based on a pre-arranged business agreement.

Although the example described above is based on using a merchant's smart phone, a desktop computer may also be used by a shop owner at a checkout counter to process payment using bank account information embossed on a customer's debit card.

Although the example described above is based on using a consumer's (i.e., Mary's) debit card to process a payment using the embossed bank account information, other types of financial card having embossed bank account information may also be used. For example, a credit card issuing bank may also offer a depository bank account to Mary. In such case, Mary may have a credit card that is embossed with a credit card number, a debit card number, and a bank account number/routing number. In another example, a combination financial card may be issued by a financial institution or a third party service provider (e.g., a bill-pay service provider, such as the aforementioned ABC.GoPayment) to have multiple embossed card numbers and bank account numbers from multiple issuing banks or financial institutions. In such example, the financial card template would identify the location of each of the multiple embossed card numbers and bank account numbers/codes. Accordingly, the smartphone application (e.g., the aforementioned ABC.GoPayment.Xpress) allows the merchant to select any of the offered payment options (e.g., using a selection menu similar to the screenshot A (300a)) to process a consumer's payment. For example, using Mary's financial card embossed with her credit card number, her debit card number, and her bank account number/routing number, John can select to process the payment as a credit card transaction via a card processing network (e.g., the aforementioned XYZ credit card processor) using the OCRed credit card number, process the payment as a debit card transaction via the card processing network (e.g., the aforementioned XYZ credit card processor) using the OCRed debit card number, or process the payment as an EFT via the core banking systems, as described above, using the OCRed banking account information and related code. For example, Mary can instruct John as to which payment option she prefers. In addition, Mary can use her combination financial card to pay a merchant who already accepts credit card or to pay another merchant who has not yet set up to accept credit card. For example, the another merchant may download, at the point of sale, the “ABC.GoPayment.Xpressy” by following set up instructions included on Mary's combination financial card.

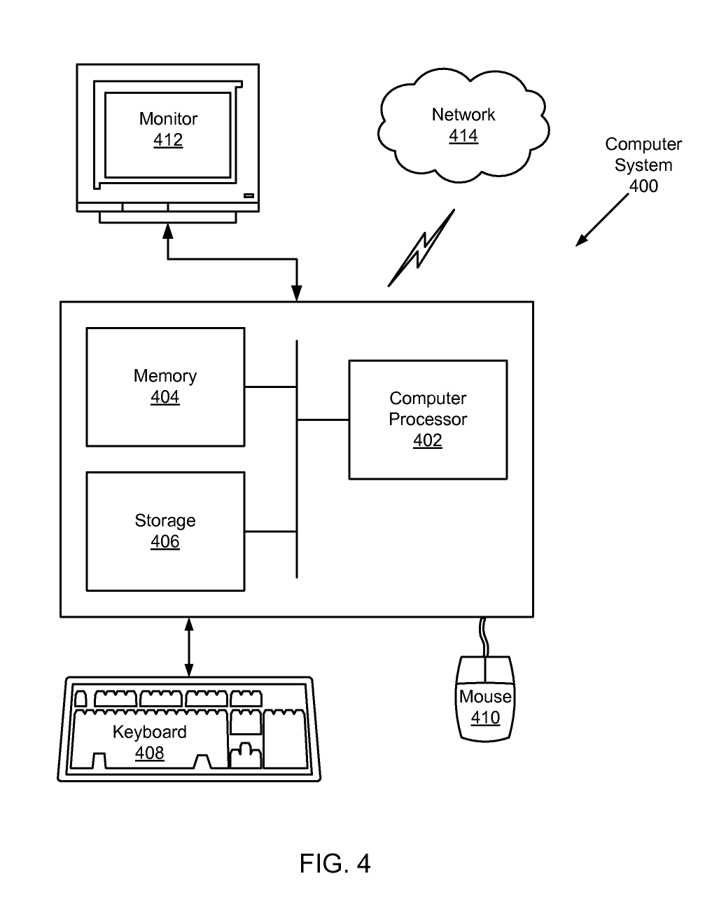

Embodiments of the invention may be implemented on virtually any type of computer regardless of the platform being used. For example, as shown in FIG. 4, a computer system (400) includes one or more computer processor(s) (402) such as a central processing unit (CPU), integrated circuit, or other hardware processor, associated memory (404) (e.g., random access memory (RAM), cache memory, flash memory, etc.), a storage device (406) (e.g., a hard disk, an optical drive such as a compact disk drive or digital video disk (DVD) drive, a flash memory stick, etc.), and numerous other elements and functionalities typical of today's computers (not shown). The computer system (400) may also include input means, such as a keyboard (408), a mouse (410), or a microphone (not shown). Further, the computer system (400) may include output means, such as a monitor ((412) (e.g., a liquid crystal display (LCD), a plasma display, or cathode ray tube (CRT) monitor). The computer system (400) may be connected to a network (414) (e.g., a local area network (LAN), a wide area network (WAN) such as the Internet, or any other similar type of network)) with wired and/or wireless segments via a network interface connection. Those skilled in the art will appreciate that many different types of computer systems exist, and the aforementioned input and output means may take other forms. Generally speaking, the computer system (400) includes at least the minimal processing, input, and/or output means necessary to practice embodiments of the invention.

Further, those skilled in the art will appreciate that one or more elements of the aforementioned computer system (400) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions for performing embodiments of the invention may be stored on a non-transitory computer readable storage medium such as a compact disc (CD), a diskette, a tape, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method to complete a sales transaction, comprising:
obtaining, by a merchant mobile device of a merchant, a digital image of a financial card of a consumer, wherein the digital image captures a code and an account number displayed in a text format on the financial card;
requesting, in response to obtaining the digital image, a payment of the sales transaction by:
extracting, by a processor of the merchant mobile device using optical character recognition of the digital image, the account number and the code,
identifying a depository financial institution and a consumer financial account based on the code and the account number, respectively, wherein the consumer financial account is held at the depository financial institution and controlled by the consumer, and
sending a request to the depository financial institution to transfer, via an electronic funds transfer, an amount of the payment from the consumer financial account to a merchant financial account controlled by the merchant; and
receiving, by the merchant mobile device, a confirmation of completing the electronic funds transfer,
wherein the sales transaction is completed in response to the confirmation.

2. The method of claim 1, wherein the digital image is generated using camera functionality of the merchant mobile device.

3. The method of claim 1, wherein the identifying and the sending are performed by at least one selected from a group consisting of the processor of the merchant mobile device and a computer server coupled to the merchant mobile device.

4. The method of claim 1, wherein completing the electronic funds transfer comprises:
receiving, by the depository financial institution via the merchant mobile device, an authorization by the consumer as a part of the request;
transferring, in response to receiving the authorization, the amount of the payment from the consumer financial account to the merchant financial account; and
storing a record of the authorization and the electronic funds transfer.

5. The method of claim 1, wherein completing the electronic funds transfer comprises:
sending, by the depository financial institution in response to the request, an electronic funds transfer notification to a consumer mobile device of the consumer;
receiving, by the depository financial institution from the consumer mobile device, an authorization sent by the consumer in response to the electronic funds transfer notification;
transferring, in response to receiving the authorization, the amount of the payment from the consumer financial account to the merchant financial account; and
storing a record of the authorization and the electronic funds transfer.

6. The method of claim 1, wherein completing the electronic funds transfer comprises:
obtaining an authorization from the consumer for authorizing the depository financial institution to issue an automated clearing house (ACH) transaction, wherein the ACH transaction comprises debiting the consumer financial account; and
storing a record of the authorization and the ACH transaction,
wherein the request comprises an ACH transfer entry package instructing the depository financial institution to initiate the electronic funds transfer using the ACH transaction based on the authorization.

7. The method of claim 1,
wherein the sales transaction comprises a purchase of a merchandise from the merchant by the consumer,
wherein the financial card further comprises a credit card number to identify a credit card account that is separate from the financial account at the depository financial institution, and
wherein the consumer purchases, in another sales transaction using the financial card and based on the credit card number, another merchandise from another merchant having a dedicated financial card processing device.

8. The method of claim 1,
wherein the sales transaction comprises a purchase of a merchandise from the merchant by the consumer,
wherein the financial card further comprises a debit card number to identify the financial account at the depository financial institution, wherein the debit card number is separate from the code and the account number on the financial card, and
wherein the consumer purchases, in another sales transaction using the financial card and based on the debit card number, another merchandise from another merchant having a dedicated financial card processing device.

9. The method of claim 1,
wherein the electronic fund transfer is performed over a proprietary network configured to facilitate direct communication between the depository financial institution and a bank where the merchant account is held, and
wherein the proprietary network is one selected from the group consisting of a mobile telephone network, a television-cable network, and a public switched telephone network (PSTN).

10. A system for completing a sales transaction, comprising:
a merchant mobile device of a merchant, configured to:
obtain a digital image of a financial card of a consumer, wherein the digital image captures a code and an account number displayed in text format on the financial card,
extract, using optical character recognition of the digital image, the account number and the code, and
receive a confirmation of transferring, via an electronic funds transfer from a consumer financial account controlled by the consumer to a merchant financial account controlled by the merchant, an amount of a payment for the sales transaction,
wherein the sales transaction is completed in response to the confirmation;
a processor of a computer server;
a payment engine executing on the processor and configured to:
identify a depository financial institution and the consumer financial account based on the code and the account number, respectively, wherein the consumer financial account is held at the depository financial institution, and
send a request to the depository financial institution to compete the electronic funds transfer; and
a repository coupled to the processor and configured to store the code, the account number, and a record of the electronic funds transfer.

11. The system of claim 10, wherein the merchant mobile device comprises a camera configured to generate the digital image.

12. The system of claim 10, wherein the merchant mobile device comprises a portion of the processor of the computer server.

13. The system of claim 10, wherein completing the electronic funds transfer comprises:
receiving, by the depository financial institution via the merchant mobile device, an authorization by the consumer as a part of the request; and
transferring, in response to receiving the authorization, the amount of the payment from the consumer financial account to the merchant financial account.

14. The system of claim 10, wherein completing the electronic funds transfer comprises:
sending, by the depository financial institution in response to the request, an electronic funds transfer notification to a consumer mobile device of the consumer;
receiving, by the depository financial institution from the consumer mobile device, an authorization sent by the consumer in response to the electronic funds transfer notification; and
transferring, in response to receiving the authorization, the amount of the payment from the consumer financial account to the merchant financial account.

15. The system of claim 10, wherein completing the electronic funds transfer comprises:
obtaining an authorization from the consumer for authorizing the depository financial institution to issue an automated clearing house (ACH) transaction, wherein the ACH transaction comprises debiting the consumer financial account; and
storing a record of the authorization and the ACH transaction,
wherein the request comprises an ACH transfer entry package instructing the depository financial institution to initiate the electronic funds transfer using the ACH transaction based on the authorization.

16. The system of claim 10,
wherein the sales transaction comprises a purchase of a merchandise from the merchant by the consumer,
wherein the financial card further comprises a credit card number to identify a credit card account that is separate from the financial account at the depository financial institution, and
wherein the consumer purchases, in another sales transaction using the financial card and based on the credit card number, another merchandise from another merchant having a dedicated financial card processing device.

17. The system of claim 10,
wherein the sales transaction comprises a purchase of a merchandise from the merchant by the consumer,
wherein the financial card further comprises a debit card number to identify the financial account at the depository financial institution, wherein the debit card number is separate from the code and the account number on the financial card, and
wherein the consumer purchases, in another sales transaction using the financial card and based on the debit card number, another merchandise from another merchant having a dedicated financial card processing device.

18. The system of claim 10,
wherein the electronic fund transfer is performed over a proprietary network configured to facilitate direct communication between the depository financial institution and a bank where the merchant account is held at, and
wherein the proprietary network is one selected from the group consisting of a mobile telephone network, a television-cable network, and a public switched telephone network (PSTN).

19. A non-transitory computer readable medium storing instructions to complete a sales transaction, the instructions comprising functionality to:
obtain, by a merchant mobile device of a merchant, a digital image of a financial card of a consumer, wherein the digital image captures a code and an account number displayed in a text format on the financial card;
request, in response to obtaining the digital image, a payment of the sales transaction by:
extracting, using optical character recognition of the digital image, the account number and the code,
identifying a depository financial institution and a consumer financial account based on the code and the account number, respectively, wherein the consumer financial account is held at the depository financial institution and controlled by the consumer, and
sending a request to the depository financial institution to transfer, via an electronic funds transfer, an amount of the payment from the consumer financial account to a merchant financial account controlled by the merchant; and
receive, by the merchant mobile device, a confirmation of completing the electronic funds transfer,
wherein the sales transaction is completed in response to the confirmation.

20. The non-transitory computer readable medium of claim 19, wherein the digital image is generated using camera functionality of the merchant mobile device.

21. The non-transitory computer readable medium of claim 19,
wherein the sales transaction comprises a purchase of a merchandise from the merchant by the consumer,
wherein the financial card further comprises a credit card number to identify a credit card account that is separate from the financial account at the depository financial institution, and
wherein the consumer purchases, in another sales transaction using the financial card and based on the credit card number, another merchandise from another merchant having a dedicated financial card processing device.

22. The non-transitory computer readable medium of claim 19,
wherein the sales transaction comprises a purchase of a merchandise from the merchant by the consumer,
wherein the financial card further comprises a debit card number to identify the financial account at the depository financial institution, wherein the debit card number is separate from the code and the account number on the financial card, and
wherein the consumer purchases, in another sales transaction using the financial card and based on the debit card number, another merchandise from another merchant having a dedicated financial card processing device.

23. The non-transitory computer readable medium of claim 19,
wherein the electronic fund transfer is performed over a proprietary network configured to facilitate direct communication between the depository financial institution and a bank where the merchant account is held, and
wherein the proprietary network is one selected from the group consisting of a mobile telephone network, a television-cable network, and a public switched telephone network (PSTN).
